(19) United States
(12) Patent Application Publication
(10) Pub. No.: US 2008/0239644 A1
(43) Pub. Date: Oct. 2, 2008

(54) Display systems manufactured by co-manufacturing printing processes

(76) Inventors: Michael Cassidy, Dublin 6 (IE); Alain Braincon, Poolesville, MD (US); David Corr, Dublin 14 (IE); Michael Ryan, Dublin (IE); Henrik Lindstrom, Dublin 18 (IE); Martin Moeller, Dublin 16 (IE)

Correspondence Address: MORGAN, LEWIS & BOCKIUS LLP, 1701 MARKET STREET, PHILADELPHIA, PA, 19103-2921, US

(21) Appl. No.: 12/077,789

(22) Filed: Mar. 21, 2008

Related U.S. Application Data
(60) Provisional application No. 60/896,101, filed on Mar. 21, 2007.

(51) Int. Cl. G06F 1/16; B05D 5/12

(52) U.S. Cl. 361/681; 427/108

(57) ABSTRACT

Electronic systems and method to make such electronic systems using co-processing print technology. In one embodiment, the electronic system includes a substrate, a printed display device, a printed component and a printed functional layer. The printed display device includes a transparent conductor layer positioned on the substrate and at least one display layer positioned on the transparent conductor layer. The printed component is positioned on the substrate and includes at least one component layer. The printed functional layer is associated with the printed display device and the printed component where the printed functional layer characterized by a chemical property or physical property that allows said printed functional layer to serve as a component layer and a display layer.

### RELATED APPLICATIONS

This application claims the benefit of U.S. Provisional Application No. 60/896,101, filed Mar. 21, 2007, entitled “Expanded and Accelerated Commercial Road Map Items” which is incorporated herein by reference in its entirety.

### FIELD OF INVENTION

This invention relates to electronic systems having displays and other components. In particular, it relates to methods of manufacturing the electronic systems where a printing process is used so that layers common to both the display device and at least one other component are printed in the same print cycle.

### BACKGROUND OF INVENTION

Providing a display device in an electrical system enables the user to interact with the system in a unique way by enabling a visual indication of a system event. Displays in the context of low-cost and high-volume applications can range from a single color-changing element up to multi-segment and high-resolution pixellated devices.

In order for displays to enter some very high volume applications it is desirable and in some cases essential to reduce the cost of production of not only the display element but of the entire electrical system. Such applications may include smart labels, smartcards, novelty items, greetings cards, toys, disposable applications and others. Advances in manufacturing of displays have been demonstrated with electrochromic displays in particular, with fully printable solutions in state of the art devices. Printing methods can include screen-printing, flexographic printing, ink-jet printing, and gravure printing amongst others. One advantage of print methodologies is that they support additive processes that only use the required amount of material for a layer and do not require additional etching processes thereby saving material costs and processing time. Additionally, print processes support in-line and roll processing which enables high throughput and lower cost manufacturing.

Often display elements are manufactured by non-print methods, including processes such as sputtering, etching and vacuum filling which are slow and costly processes. The state-of-the-art in low-cost display manufacturing is in printing of display elements as this allows for fully additive processes that are cost effective and high throughput processing which enable lower cost.

### SUMMARY OF THE INVENTION

The present invention provides processing methods to enable low-cost market opportunities by providing means whereby a display element may be co-processed with other required elements of an electronic system as required for each application. The present invention also provides of systems made by such methods.

The present disclosure provides for various electronic systems and methods to make such electronic systems using co-processing print technology. In one embodiment, the electronic system includes a substrate, a printed display device, a printed component and a printed functional layer. In one embodiment, the printed display device includes a transparent conductor layer positioned on the substrate and at least one display layer positioned on the transparent conductor layer. The printed component is positioned on the substrate and includes at least one component layer. In one embodiment, the printed functional layer is associated with the printed display device and the printed component where the printed functional layer characterized by a chemical or physical property that allows said printed functional layer to serve as a component layer and a display layer.

In one embodiment, the printed component includes a power supply such as an RF antenna, a solar cell or a battery.

In another embodiment, the printed component includes a sensor such as a temperature sensor, an oxygen sensor, a chemical sensor, or a glucose sensor.

In yet another embodiment, the printed component includes an active electrical component.

The present invention further provides for an electronic system including a substrate, one or more printed electrical components, a printed electrochromic display device and one or more printed functional layers. In one embodiment, the one or more printed electrical components are associated with the substrate and have at least one component layer. The one or more printed functional layers are characterized by a chemical or physical property that allows said printed functional layer to serve as a component layer and a display layer. In one embodiment, the printed electrochromic display device is associated with the substrate and has at least one display layer, a first electrode having a first electrochemical potential, a second electrode having a second electrochemical potential and a color changing electrode. In one embodiment, the color changing electrode switches between a first redox state and a second redox state at an electrochemical potential between the first electrochemical potential and second electrochemical potential. The color changing electrode switches to the first optical state by connecting to the first electrode and the second electrode is connected to the printed electronic components to thereby provide power for said printed electronic components.

In one embodiment, the present invention further provides for a method of co-manufacturing an electrical system. At least one functional layer, a display device and one or more components are printed onto a substrate. In one embodiment, the printed display device has at least one display layer. In one embodiment, the printed component has at least one component layer. The printed functional layer is characterized by a chemical or physical property that allows said printed functional layer to serve as a component layer and a display layer.

In one embodiment, the present invention further yet provides for a method of co-manufacturing an electronic system. A component layer is printed onto a flexible substrate or an underlying component layer. The component layer and the underlying component layer contains a component composition used to build a component stack. A display device layer is printed onto the flexible substrate or an underlying display layer. The display device layer and underlying display layer contains a display device composition used to build a display device stack. A functional layer is printed in a single printing step where the functional layer is common to each of the component stack and the display device stack. The printed functional layer is characterized by a chemical or physical property that allows the printed functional layer to serve as a component layer and a display layer. One or more of the printing steps are repeated to thereby form an electronic device.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 schematically represents an exemplary prior art system;

FIG. 2 schematically represents an exemplary system of the present invention;

FIG. 3 schematically represents an exemplary system of the present invention;

FIG. 4 schematically represents an exemplary system of the present invention;

FIG. 5 schematically represents an exemplary system of the present invention;

FIG. 6 schematically represents an exemplary system of the present invention;

FIG. 7 schematically represents an exemplary printing method of the present invention.

### DETAILED DESCRIPTION OF THE DISCLOSURE

Reference will now be made in detail to the preferred embodiments of the present disclosure, examples of which are illustrated in the accompanying drawings. Wherever possible, the same reference numbers will be used throughout the drawings to refer to the same or like parts.

In one embodiment, the present invention describes electronic systems and a method of manufacturing such electronic systems where the system is composed of multiple electronic components and a display supported on a common substrate. In such a method, it is necessary to consider: the alignment and sequencing of print materials; the selection of materials that are functional layers in multiple components; and the engineering of the printing stack so that common layers are printed in one pass. The printing stack refers to the layering of materials, for a component or display device, from the substrate up to the final layer which is often an encapsulation layer. The selection of materials and engineering the layer sequence in the printing stack constitute a large part of this process. It is necessary to consider the deposition of the preceding and subsequent layers so to match the physical performance requirements of a functional layer(s) across two or more electronic components. For example, this could extend to ink engineering or stack engineering to account for the alignment required of a material functional layer in each component or to the requirement for processing temperature tolerances of subsequent layers.

The examples described herein predominantly describe print deposition methods for most or all of the layers as this approach provides the most cost effective solution. However other deposition methods may be used within the system where this is appropriate or necessary for a particular material or layer characteristic. The examples described herein of electrical systems are not intended to be exhaustive as the invention relates to any electronic system comprising two or more elements where printing can be used for all or part of the elements. Similarly, the more commonality that can be drawn between these printed components, the greater the level of functionality that can be achieved at low-cost and the greater the range of markets that can be addressed.

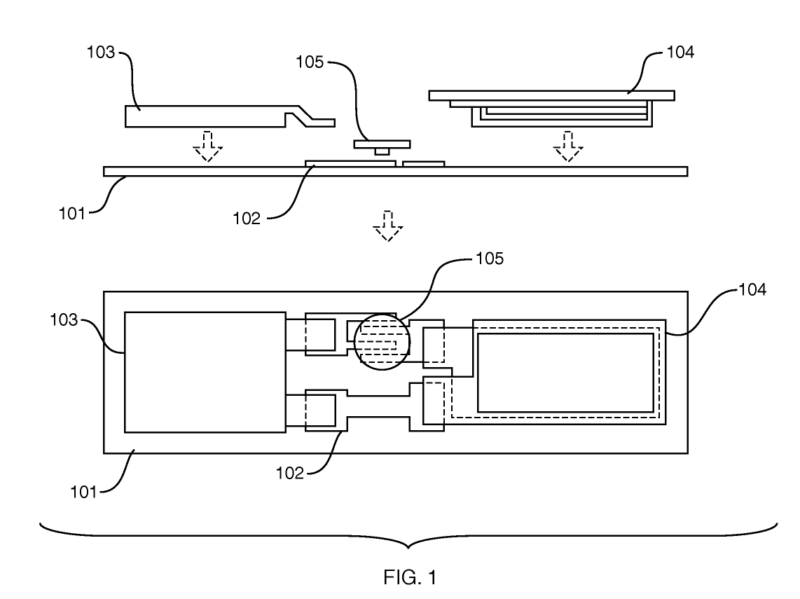

FIG. 1 shows a cross sectional and plan view of a prior art example of a simple novelty display application. Such a system might contain three individual components that are currently manufactured separately and brought together in a final module construction. With reference to the figure, 101 is a substrate that carries a patterned conductor, 102 and a switch device, 105. The switch drawing is shown for illustrative purposes only. A battery component, 103 and a display component, 104, are independently manufactured by printing means and each of the individual components are brought together and bonded onto the carrier substrate, 101. The layer structure of the display component, 104, is shown for illustrative purposes only. It may be seen that each component must be manufactured on its own substrate and thus the cost of substrate materials is higher than if it were common. Additionally, each time a material is used in a component, even if it is common to another component, the deposition cost for that material is repeated.

The present disclosure provides for various electronic systems and method to make such electronic systems using co-processing print technology. In one embodiment, the electronic system includes a substrate, a printed display device, a printed component and a printed functional layer. The substrate includes flexible material such as PET, PETG, PEN, thin glass, bendable glass, any other transparent material, paper, calendar paper, cladded paper and card board. The printed display device includes a transparent conductor layer positioned on the substrate and at least one display layer positioned on the transparent conductor layer. The printed component is positioned on the substrate and includes at least one component layer. The printed functional layer is associated with the printed display device and the printed component where the printed functional layer characterized by a chemical or physical property that allows said printed functional layer to serve as a component layer and a display layer. The printed display device has at least one display layer deposited onto the substrate via a printing process to form a display print stack. Also the printed components have at least one printed component layer deposited onto the same substrate to form a component print stack. The printed components may serve a variety of functions in the electronic system.

The printed functional layer, common to the printed display device and printed components, serves a variety of functions. These functions include one or more of the following: transferring charge from components and/or the display device at a predetermined voltage; transfer light into charge; regulate the transfer of current between components and/or the display device, and transform pressure into charge.

In one embodiment, the printed functional layer includes a conductive material. The composition of the conductive functional layer includes carbon, nickel, tin, cobalt, iron, zinc, silver, copper, gold, metal alloys or conducting polymer. In one such embodiment, the conductive function layer is made from carbon.

In another embodiment, the printed functional layer includes a metal oxide semiconductor material. In one such embodiment, the metal oxide semiconductor material is transparent. The composition of the metal oxide semiconductor functional layer includes ITO, FTO, TiO2, PTO, ATO and mixtures thereof.

In yet another embodiment, the printed functional layer includes electrochromophore material. Examples of electrochromophores, which may be used to a printed electrochromophore functional layer are described in U.S. Patent Application Publication No. 2006.0110638, entitled “Electrochromic Compounds,” and is incorporated by reference herein in its entirety.

In still another embodiment, the printed functional layer includes a separator layer. Representative compositions of a printed separator layer include paper, rubber, silica, porous glass, plastic, or ceramic material.

In still yet another embodiment, the printed functional layer includes an electrolyte material. Examples of electrolyte material include solid electrolyte containing an electrochemically inert ionic compound, a gel containing an electrochemically inert ionic compound, an ion conductor or a proton conductor.

The printed display device may be based on a variety of displays such as electrochromic displays, thermo-chromic displays, electroluminescent displays, electrowetting displays, electrophoretic displays and other reflective and emissive displays. For an exemplary electrochromic display, the display print stack includes layers having representative compositions of: a transparent conductor, a nanostructured semiconducting metal oxide; an electrolyte; an electrochromophore, a metal-oxide semiconductor counter electrode, a separator material. One of such layers is common to the component print stack. Representative materials used to make an electrochromic display are described in U.S. Pat. No. 6,301,038, U.S. Pat. No. 6,605,239, U.S. Pat. No. 6,755,993 and U.S. Pat. No. 6,870,657 each of which is incorporated herein by reference in its entirety. For a thermo-chromic display, one of the layers within the display print stack includes at least one thermochromic material which changes color as the temperature of the material increases beyond a thermal threshold. The display print stack may also include material to form a thermal insulation layer. Representative materials used to make a thermochromic display are described in U.S. Pat. No. 5,557,208 which is incorporated herein by reference in its entirety. For a printed electroluminescent display, one of the layers within the display print stack includes glass encapsulated phosphors or phosphor crystals embedded in a polymer binder or an electroluminescent polymer. An electrophoretic display print stack includes at least one layer containing encapsulated charged particles in a gas or liquid medium, often referred to as an electronic ink. Representative electronic inks are described in U.S. Pat. No. 5,930,026, U.S. Pat. No. 5,754,332, and U.S. Pat. No. 6,850,355 each of which is incorporated herein by reference in its entirety.

In one embodiment, the printed component corresponds to a power source used to power the display. Exemplary power sources include a battery, a solar cell or a RF source. For such power sources, the common printed functional layer includes a printed conductor material or a printed semiconductor material. The printed conductor includes carbon, nickel, tin, cobalt, iron, zinc, silver, copper, gold, metal alloys or conducting polymer.

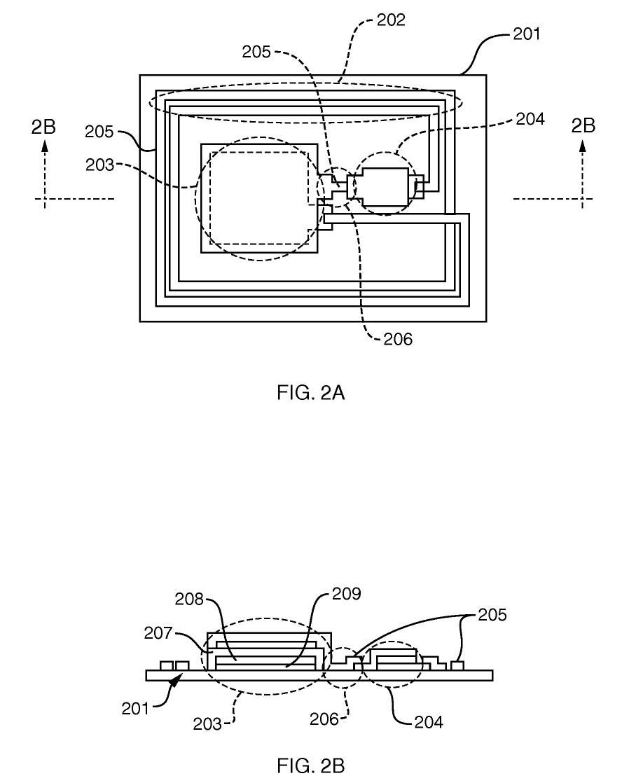

FIG. 2 shows an exemplary electronic system including an RF antenna 202 which serves as a power source to a display device 203. Such a system may be appropriate for a novelty application, RFID tag or remote indicator. The RF antenna 202 and a display device 203 are associated with substrate 201 which are co-manufactured by printing a conductive functional layer 205 for the RF antenna 202 and the top layer of the display device 203. Exemplary compositions of the substrate material include many polymeric materials that provide flexibility to the substrate. The display device 203 include a plurality of display device layers including a conductor layer 205, a electrical separator layer 207 supporting ionic conduction, an electrochromophore layer 208 and a transparent metal oxide conductor layer 209. In one embodiment, the functional layer 205 may be made from a conductive material such as carbon. The system includes an RF rectifier 204 placed between the display device 203 and the RF antenna 202 to convert the RF signal to a usable DC power source for the display device 203. The RF antenna 202 is formed from the looping of multiple traces of the conductive layer 205. The functional conductor layer 205, is common to the RF antenna 202, the interconnect 206 between the RF antenna 202 the RF rectifier 204 and the display device 203. A layer stack of the RF rectifier 204 is shown for illustrative purposes only. In one embodiment, the conductive layer 205 serves as a functional layer for the RF rectifier 204.

A printed display element in combination with a printed RFID tag and antenna could provide a smart label device that could be incorporated into the multi-billion annual unit demand for labels that exist worldwide. RFID labelling is expected to become widespread in the areas of stock control, shipping, inventory management and security amongst others. Such a system could also provide a method for verification of the RFID functionality.

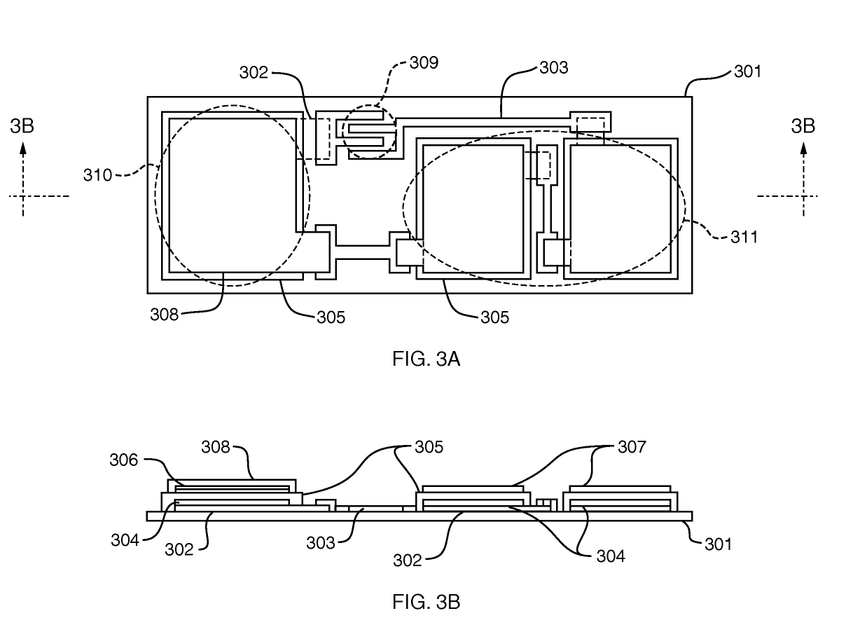

In another embodiment, a solar cell functions as the printed component to supply power to the display device. An exemplary system is shown in FIG. 3 where a display component 310 is co-manufactured with solar cell devices 311. Two solar cells are shown in series in order to increase the system voltage. The display 310 and the two solar cells 311 are connected by a conductive layer 303 deposited on a substrate layer 301. A transparent metal oxide conductive functional layer 302 is common to the display element 310 and the solar devices 311 and provides a conductive path for a second shared functional layer 304 which is a metal oxide semiconductor. The metal-oxide semiconductor may be ITO, FTO, TiO2, PTO, ATO and mixtures thereof which convert light to charge through direct photo-absorption. The electrical system may optionally include another functional layer (not shown) of a photosensitive dye, such as an electrochromophore, which is chemically or physically adsorbed to the metal oxide semiconductor layer 304. In such a configuration, light is adsorbed by the electrochromophore/metal oxide semiconductor complex and then converted to charge. The electrical system may further include a printed functional layer (not shown) containing a printed electrolyte where the electrolyte functional layer is common between the solar cells 311 and the display device 310. A further shared functional layer 305 is an electrical separator layer supporting ionic conduction is printed on stacks of the display device and the solar cell components. The display component 310 and the solar cell devices 311 each have a counter electrode, 306 and 307 respectively. A further display conductive layer 308 is deposited on the display component. A switch element 309 (not illustrated) may be added in a simple configuration to open and close the circuit.

In another embodiment, one or more printed components, of the electrical system, function as sensors. Exemplary sensors include temperature sensors, humidity sensors, oxygen sensors, touch sensors, light sensors, chemical sensors or other physical or electronic sensors. Such electrical systems could be used in shipment of food products to measure and demonstrate if a perishable good has been stored outside of the recommended range.

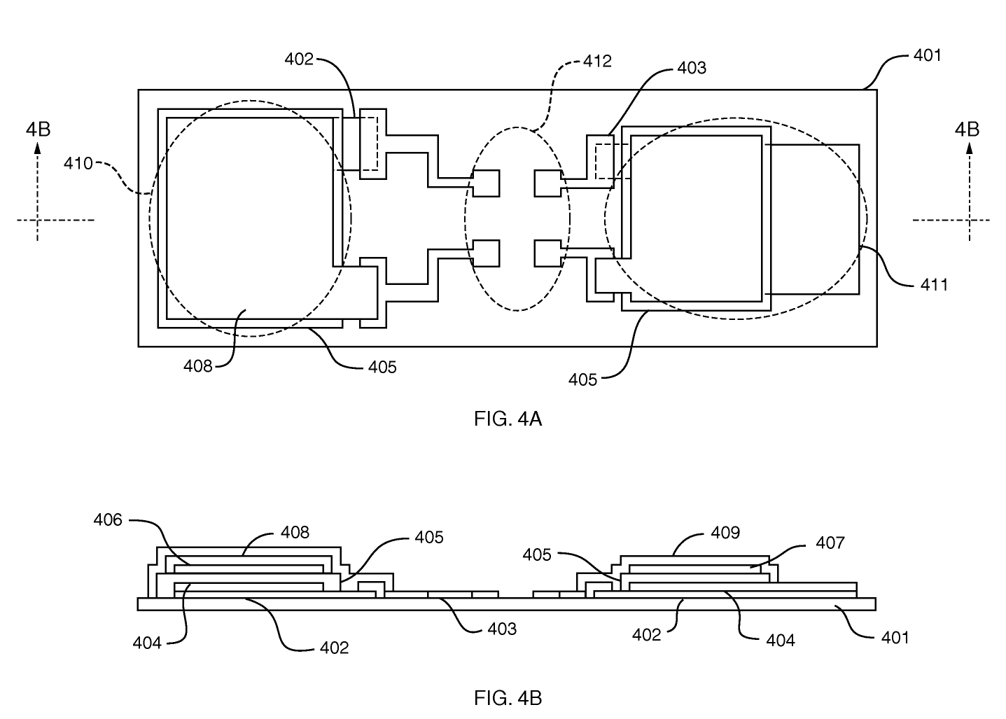

An exemplary electrical system is shown in FIG. 4 including a display device 410, a sensor 411 and multiple layers 402, 403, 404 & 405 on a substrate layer 401. A transparent conductive functional layer 402 in combination with a nanostructured metal oxide semiconductor 404 provides a large surface area electrode in both the display component 410 and the sensor component 411. The metal-oxide semiconductor may be nanostructured ITO, FTO, TiO2, PTO, ATO and mixtures thereof. In the display component 410, this nanostructured metal oxide semiconductor provides a large surface area onto which is adsorbed an electrochromophore and thereby the density of coloration that may be achieved is amplified.

A functional layer 403 is used to interconnect the components and as the interface 412 to an external circuit. The external circuit may comprise a comparator and/or amplifier capable of detecting the current created by the sensor in response to a sample applied at the exposed end of the sensor and applying a signal to the display component to illustrate the result. The electronic amplifier circuit could potentially be fabricated on the substrate by printed active components but the detail of such a circuit or of an external circuit are beyond the scope of the invention. Additionally, if the detection amplification provided by the large surface area electrode 404 was significant enough it may be possible to interface the display 410 directly to the sensor 411.

A separator layer 405 is deposited on top of the metal oxide electrode 404 and counter electrode layers 406 and 407 are deposited on the display component 410 and the sensor component 411, respectively. A further functional conductive layer, 408 is deposited on the display component 410. The encapsulation layer 409 is shown in this example to illustrate how openings made in the layer allow access to the underlying layers. The sensor component 411 is partly exposed to allow the sample to be applied. Layer 403 is partly exposed to allow the contact pads to be available to an applied amplifier circuit 412.

Other sensor functionality may be realized by various configurations of functional printed layers including a semiconducting layer. In one embodiment, when the sensor functions as a temperature sensor, a change in conductivity of said semiconductor material is measured using a circuit capable of detecting the change in potential across the material. Such a circuit could be an amplifier or comparator.

A printed display element in combination with a printed environmental sensor may be used to measure and demonstrate if a perishable good has been stored outside of the recommended temperature range. Such a system has a vast potential market in terms of shipment of food products.

In one embodiment, the sensor is a chemical sensor. Such a sensor could detect gaseous hydrocarbons such as methane or ethane, carbon monoxide or hydrogen peroxide.

In one embodiment, the sensor may be used to detect glucose levels. In such embodiment, component 411 includes the large surface area electrode provides a surface onto which a glucose sensitive enzyme may be attached and thus amplify the detection of glucose. Typically, the enzyme is glucose oxidase which reacts with glucose to create hydrogen peroxide. The hydrogen peroxide is in turn reduced at the electrode and creates a proportional current in the electrode which may be measured. Other enzymes with sensitivities to other biomarkers may be used. Next generation sensors work upon the detection of other substances including neurotransmitters such as glutamate/glutamate oxidase.

Glucose sensors are an area where the use of a low cost system manufactured in accordance with the present invention could provide a means of providing a device that suits the low-cost requirements of a disposable sensor that is used by millions of users, several times a day. In addition, the provision of a printed display based system means that the complete functionality of the detector and read-out for the patient can be incorporated into one printed system.

Glucose sensors may detect the change in current flowing in the sensor electrode as a result of the reduction of hydrogen peroxide at the electrode. The current can often be difficult to detect due to the small surface area involved in the reaction. Glucose sensors could benefit from having an electrode layer with a substantially increased surface area. Such an electrode could be provided by a nano-structured metal-oxide semiconductor such as TiO2, ITO, FTO, ATO, PTO or others. In line with an embodiment of the current invention, the deposition stack can be engineered in such a way that enables an electrode of the display system to be printed at the same time as an electrode in the sensor. Additional layers, including conductive interconnect, electrolyte, and seal materials may also be commonly printed for the system, thereby enabling ultra-low cost display-sensor systems.

In one embodiment, when a sensor functions as an oxygen sensor, the sensor generates a current in proportion to an amount of oxygen reduced at the semiconducting electrode.

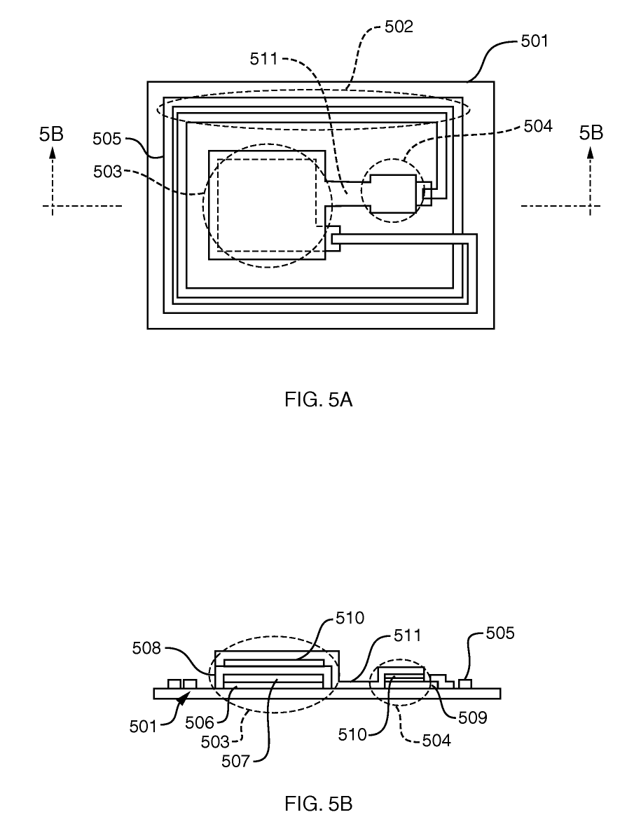

In one embodiment, the present disclosure also provides for an electronic system having a display device, one or more active components and at least one functional layer wherein one or more functional layers of good conductivity are common to the printed display device connections and printed active components. FIG. 5 shows such an exemplary system. In one embodiment, an RF antenna 502, display component 503 and a diode device 504 are co-manufactured on a common substrate 501. The RF antenna 502 is formed from the looping of multiple traces of the conductive layer 505. Additionally, a printed semiconducting functional layer 510 is printed so it is common between the diode 504, and the display component 503. In the diode for example, this semiconductive functional layer 510 could form one side of a Schottky junction, acting as an RF rectifier. In the display component, the semiconductor functional layer 510 is shown printed above a stack containing a transparent conductor layer 506, a second metal oxide semiconductor 507 and a separator layer 508 and could function as the cathode material or anode material of a printed electrochromic display. An additional component layer 509 is printed for the anode of the diode and would be chosen to have the correct work function to ensure the diode device performs properly. However, it is possible that layer 509 could be the same as layer 505 and thus printed in the same step. A further conductive functional layer 511 is also printed to be common between the display component 503 and the diode component 504. This layer might typically be a conductive carbon layer. In this example, by using co-manufacture printing techniques of such a display based system, it would be possible to make two or three functional layers common to three components, significantly reducing the overall cost of manufacturing of the system when compared with the current art.

In certain embodiments, the printed active components include a variety of active electrical components such as: a terminal contact for a diode; a terminal of a MIM diode; a terminal of a Schottky diode; a metal gate or an electrode contact of a transistor; contact pad for connection to a mounted component; contact of a switch; contact pad for interfacing the electronic system to external devices; a battery contact; a solar cell contact; a resistor; a sensor contact; a sensor electrode contact; a capacitor contact; or electrode. In one embodiment, the active device is a transistor where the semiconductor layer is used to provide the channel of the transistor. The conductivity of the semiconductor layer may be modified between a substantially conducting state and a substantially non-conducting state by application of an electric potential on a gate electrode. In another embodiment, the active device is a diode. The semiconducting layer is used to provide one electrode of the diode. The layer is in direct contact with a metal electrode having a suitable work function so as to create a Schottky junction at the interface semiconductor layer and the metal electrode. In still another embodiment, the functional layer is made of a printed conductor material printed as a meandering conductive trace that fulfils the functionality of a resistor and of the interconnect to a display component. The resistance of the resistor may be designed by modulating the width and length of this conductive trace. In yet another embodiment, the functional layer is made of a printed conductor material that fulfils the functionality of a mounting or contact pad for one or more of the following: an affixed fabricated component; an interface to an external system; and the interconnect to the display device. The mounting or contact pad is designed to match the interface and bonding requirements of the attached component or external device. In accordance with another embodiment, the functional layer is made of a printed conductor material functioning as a capacitor electrode and the interconnect to a display component. The capacitor electrode is designed to have an area appropriate to the required capacitance of a parallel plate capacitor. In such embodiment, there is also a subsequent or underlying functional layer on the capacitor plate which is made from a dielectric material.

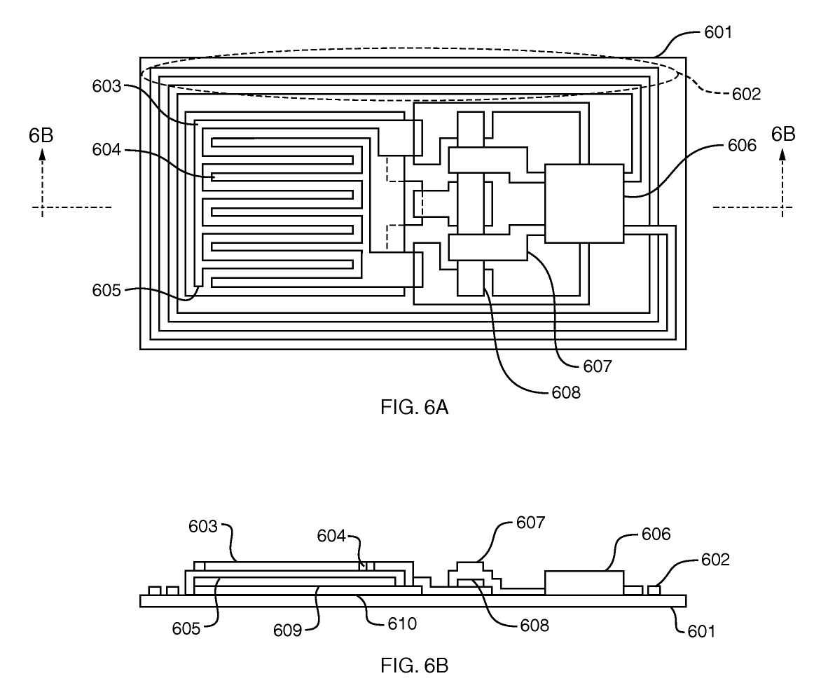

The present disclosure further provides for an electronic system having a printed electrochemical display device, a printed battery, one or more active printed components and at least one printed functional layer. FIG. 6 shows an exemplary electronic system as a plan and cross-sectional view of a combined display and battery system which are co-printed with an active RFID tag. In this embodiment, the display device and battery are designed as an integrated display-battery. Such a device is further described in U.S. Provisional Application No. 60/980,076, filed Nov. 15, 2007, entitled “Self Powering Displays for Labels and Cards,” which is incorporated herein by reference in its entirety. In one embodiment, the method of co-manufacturing of the present disclosure allows for the printed battery and printed electrochemical display device to occupy a reduced area on a substrate and also allows for the chemical energy available in the electrochemical display component to be used to power additional components within the system. In FIG. 6, interdigitated electrodes 603 are 604 are two terminals of an electrochemical cell. In one embodiment, the electrode composition may include zinc, for the first electrode and a combination of manganese dioxide (not shown) and carbon for the second electrode. Layer 605 acts as a separator layer between these electrodes 603 and 604 and a third electrode 609 which is an electrochromic electrode. The electrochromic electrode 609 exhibits different colored states depending on whether it is connected to electrode 603 or electrode 604. Layer 610 is a transparent conductor that increases the conductivity across the electrochromic layer. In the example, layers 607 and 608 function as gate metal and semiconductor layers, respectively, that in combination with the conductive layer 602 form a printed transistor which can be used to switch the connection between the electrodes. Layer 602 is printed down to provide the RF antenna functionality, the interconnect between the components, the mounting pads for the Integrated Circuit (“IC”) 606 the terminals of the transistors and the display connector. Additionally, the potential between electrodes 603 and 604 is used to power the IC 606 which controls the response of the display in relation to a received RF signal.

In one embodiment, a printed display element in combination with a printed battery offers the ability to apply display functionality including indicator functionality, novel functionality and text or numerical read-out to many systems. Prior art approaches attached a display element and a battery element to a substrate as two separate elements where the cost of processing two separate elements and attaching them can prove to be prohibitive for some applications.

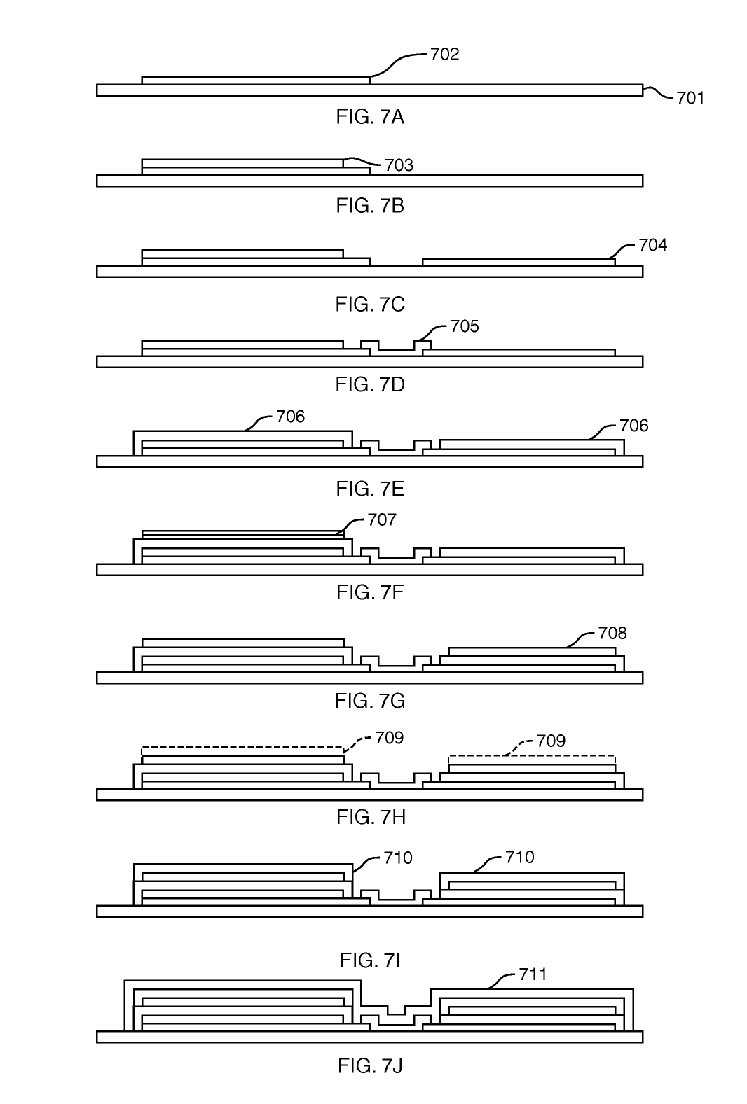

FIG. 7 gives an illustrated examinable of the process described by the invention. In this example, the functional layers used to form a combined battery and display electronic system supported a single substrate are manufactured in accordance with the present invention are shown. The diagrams are not to scale or intended to be prescriptive in the order of deposition.

A transparent conductor, 702, is deposited onto a substrate material, 701, to provide a conductive electrode for a display component. Typical materials would be a conductive metal oxide or conductive polymer on a plastic substrate. Next, the color changing electrode of a display is printed, 703. Such a layer might be a metal oxide semiconductor layer with adsorbed electrochromophore. Then, the 1st electrode a battery device is printed, 704. Such a layer might be zinc. An interconnect layer, 705, is shown connecting the 2 components, however, in a further refinement of the system and in accordance with the invention, one of the previous layers, 702 or 704, would ideally be used for this layer. In a more complex system, this layer might also act as the interconnect between other electronic components and as a functional layer in these components. The next layer is a separator layer, 706, that allows ionic conductivity but acts as an electronic insulator. Such a layer might be paper, rubber, silica, porous glass, plastic, or ceramic material. This layer shows how the process stack of both the battery and display components are considered as part of a larger system unit and through doing so, the co-manufacturing of these components may be made more cost effective and simpler through manipulation of the deposition order and of material characteristics to allow a common shared deposition across both components. A second display electrode, 707, and a second battery electrode, 708, are then printed down. Typical materials would include ATO or other metal oxides for the former and manganese dioxide for the latter. An electrolyte material, 709, is then printed into the porous material stack of each component. The electrolyte may be common to both components or optimized for the display and battery individually. Next, a conductive capping layer, 710, is printed on top of both components. This layer might be a conductive carbon layer. This again illustrates the principle of the current invention whereby the 2 components are processed as part of an overall system manufacturing approach in order to reduce the number of processing stages and materials. Finally an encapsulation layer, 711 is used to seal the system.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. An electronic system comprising:
a substrate;
a printed display device comprising a transparent conductor layer positioned on said substrate and at least one display layer positioned on said transparent conductor layer;
a printed component positioned on said substrate and comprising at least one component layer; and
a printed functional layer associated with said printed display device and said printed component;
said printed functional layer characterized by a property that allows said printed functional layer to serve as a component layer and a display layer.

2. The electronic system of claim 1, wherein said property is selected from the group consisting of: a chemical property and a physical property.

3. The electronic system of claim 2, wherein a first printed functional layer includes a printed conductor material.

4. The system wherein claim 3, wherein said printed conductor material is selected from the group consisting of: carbon, zinc, silver, copper, gold or a conducting polymer.

5. The electronic system of claim 2, wherein a first printed functional layer includes a printed semiconductor material.

6. The electronic system of claim 4, wherein at least one component comprises an RF antenna that generates an RF signal.

7. The electronic system of claim 6, further comprising an RF rectifier that converts said RF signal to a power source for said display device.

8. The electronic system of claim 7, wherein at least one component further comprises: an interconnect coupling said RF antenna, said RF rectifier and said display device.

9. The electronic system of claim 2, wherein a first printed functional layer comprises a transparent metal oxide semiconductor material.

10. The electronic system of claim 9, wherein said metal-oxide semiconductor material selected from the group consisting of: ITO, FTO, TiO2, PTO, ATO and mixtures thereof

11. The electronic system of claim 9, wherein at least one component comprises a solar cell.

12. The electronic system of claim 11, wherein a second printed functional layer contains a printed electrochromophore.

13. The electronic system of claim 12, wherein said electrochromophore being adsorbed onto said metal oxide semiconductor.

14. The electronic system of claim 13, wherein a third printed functional layer contains a printed electrolyte.

15. The electronic system of claim 9, wherein said one or more components further comprises a sensor.

16. The electronic system of claim 15, said sensor being a temperature sensor which measures a change in conductivity of said metal-oxide semiconductor during a change in temperature.

17. The electronic system of claim 15, wherein at least one component further comprises an electrode.

18. The electronic system of claim 17, wherein said electrode reduces oxygen.

19. The electronic system of claim 18, wherein said sensor being an oxygen sensor that generates a current in proportion to an amount of oxygen reduced by said electrode.

20. The electronic system of claim 15, wherein said sensor being a chemical sensor.

21. The electronic system of claim 17, wherein said sensor being a glucose sensor.

22. The electronic system of claim 21, wherein a glucose reactive enzyme being supported on said metal oxide semiconductor, said glucose reactive enzyme generating hydrogen peroxide in response to reacting with glucose, and wherein said sensor generates a current in response to an amount of hydrogen peroxide reduced by said electrode.

23. The electronic system of claim 3, wherein at least one component comprises a printed battery.

24. The electronic system of claim 23, further comprising at least one printed functional separator layer, said at least one printed functional separator layer supporting ionic conduction but substantially preventing electronic conduction.

25. The electronic system of claim 3, wherein said printed conductive material is selected from the group consisting of carbon, zinc, silver, copper, gold or a conducting polymer.

26. The electronic system of claim 25, wherein at least one component comprises an active device.

27. The electronic system of claim 26, wherein said active electrical device is selected from the group consisting of: a terminal contact for a diode; a terminal of a MIM diode; a terminal of a Schottky diode; a metal gate or an electrode contact of a transistor; contact pad for connection to a mounted component; contact of a switch; contact pad for interfacing the electronic system to external devices; a battery contact; a solar cell contact; a resistor; a sensor contact; a sensor electrode contact; a capacitor contact; and an electrode.

28. The electrical system of claim 27, wherein said electrical component is selected from the group consisting of: a transistor, a diode, and a resistor.

29. The electronic system of claim 28, wherein said active device being a transistor

30. The electronic system of claim 29, further comprising a printed semiconductor functional layer, said semiconductor functional layer providing a channel for said transistor and wherein the conductivity of the semiconductor functional layer may be modified between a substantially conducting state and a substantially non-conducting state by application of an electric potential on a gate electrode.

31. An electronic system comprising:
a substrate:
one or more printed electrical components associated with said substrate, said one or more printed electrical components having at least one component layer;
a printed electrochromic display device associated with said substrate, wherein said printed electrochromic display device having at least one display layer, and said printed electronic display device including a first electrode having a first electrochemical potential and a second electrode having a second electrochemical potential and a color changing electrode; and
one or more printed functional layers;
said printed functional layer characterized by a property that allows said printed functional layer to serve as a component layer and a display layer;
wherein said color changing electrode switches between a first redox state and a second redox state at an electrochemical potential between said first electrochemical potential and second electrochemical potential, and wherein the color changing electrode switches to said first optical state by connecting to said first electrode, and
wherein said second electrode being connected to said printed electronic components to thereby provide power for said printed electronic components.

32. The electronic system of claim 31, wherein said property is selected from the group consisting of: a chemical property and a physical property.

33. The electronic system of claim 32, wherein said first electrode and second electrode being associated with a first printed functional layer containing one or more of: zinc, carbon or manganese dioxide

34. The electronic system of claim 33, wherein said color changing electrode being associated with a second printed functional layer containing printed metal oxide semiconductor

35. The electronic system of claim 34, wherein said printed metal-oxide semiconductor is selected from the group consisting of: ITO, FTO TiO2, PTO, ATO or a mixture thereof.

36. The electronic system of claim 35, wherein said color changing electrode being associated with a display layer containing an electrochromophore adsorbed onto said metal oxide semiconductor.

37. A method comprising:
printing at least one functional layer;
printing a display device onto said substrate said display device having one or more display layers;
printing one or more components onto said substrate, said component having one or more component layers;
said printed functional layer characterized by a property that allows said printed functional layer to serve as a component layer and a display layer.

38. The method of claim 37, wherein said property is selected from the group consisting of: a chemical property and a physical property.

39. The method of claim 38, wherein said at least one functional layer contains a printed conductor material.

40. The method of claim 39, wherein said printed conductor comprises carbon, zinc, silver, copper, gold or conducting polymer

41. The method of claim 38, wherein said at least one functional layer contains a printed metal oxide semiconductor material.

42. The method of claim 41, wherein said printed metal-oxide semiconductor is selected from the group consisting of: ITO, FTO, TiO2, PTO, ATO and mixtures thereof.

43. The method of claim 42, further comprising:
printing one or more layers associated with said display device, wherein
a first layer contains one or more redox chromophore moieties said redox chromophore transitioning from a first redox state to a second redox state;
a second layer contains a nanocrystalline, nanoporous metal oxide; and
a third layer contains an electrolyte.

44. A method comprising:
a) printing a component layer onto a flexible substrate or an underlying component layer, said component layer and said underlying component layer containing a component composition used to build a component stack;
b) printing a display device layer onto said flexible substrate or an underlying display layer, said display device layer and underlying display layer containing a display device composition used to build a display device stack;
c) printing a functional layer in a single printing step, said functional layer being common to each of said component stack and said display device stack, said printed functional layer characterized by a property that allows said printed functional layer to serve as a component layer and a display layer.
d) repeating one or more steps of a-c to thereby form an electronic device.

45. The method of claim 44, wherein said property is selected from the group consisting of: a chemical property and a physical property.

46. The method of claim 45, wherein said printed functional layer contains a printed conductor material.

47. The method of claim 45, wherein said printed functional layer contains a printed metal oxide semiconductor material.

48. The method of claim 46, wherein said component stack is a RF antenna that generates an RF signal.

49. The method of claim 47, wherein said component stack comprises a component selected from the group consisting of: a solar cell, a sensor and a battery.

50. The method of claim 49, wherein said sensor is selected from the group consisting of: a temperature sensor, an oxygen sensor and a chemical sensor.

51. The method of claim 44, wherein said component stack comprises an active component selected from the group consisting of: a terminal contact for a diode; a terminal of a MIM diode; a terminal of a Schottky diode; a metal gate of a transistor; an electrode contact of a transistor; a contact pad for connection to a mounted component; a contact of a switch; a contact pad for interfacing the electronic system to external devices; a battery contact; a solar cell contact; a resistor; a sensor contact; a sensor electrode contact; a capacitor contact; and an electrode.

52. The method of claim 44, wherein said display device stack comprises an electrochromic display device.
